(19) United States
(12) Patent Application Publication
(10) Pub. No.: US 2020/0342438 A1
(43) Pub. Date: Oct. 29, 2020

(54) CUSTOMER-INITIATED PAYMENT SYSTEM AND PROCESS

(71) Applicant: MASTERCARD ASIA/PACIFIC PTE. LTD., Singapore (SG)

(72) Inventors: Aileen Chew, Singapore (SG); Vijin Venugopalan, Singapore (SG)

(21) Appl. No.: 16/491,807

(22) PCT Filed: Mar. 5, 2018
(86) PCT No.: PCT/SG2018/050102

§ 371 Date: Sep. 6, 2019

(30) Foreign Application Priority Data
Mar. 8, 2017 (SG) 10201701882Y

(51) Int. Cl. G06Q 20/32; G06Q 20/36; G06Q 20/38; G06Q 20/40

(52) U.S. Cl. CPC G06Q 20/3274; G06Q 20/401; G06Q 20/38215; G06Q 20/36

(57) ABSTRACT

Described herein is a customer-initiated payment system that includes an electronic device of a customer, the electronic device including at least one processor configured to: (i) process, in response to input from the customer, a digital image of a machine-readable optical code of a merchant to determine corresponding merchant information and transaction information encoded in the machine-readable optical code; (ii) access a digital wallet of the customer's electronic device to determine a token that identifies a financial transaction account of the customer; (iii) process the determined information and token to generate a transaction request message representing an identifier of the merchant, a transaction amount, and the token of the customer; and (iv) send the transaction request message to a token server to request a financial transaction involving payment of the transaction amount from the financial transaction account of the customer to a financial transaction account of the merchant.

### CROSS-REFERENCE TO RELATED APPLICATIONS

This patent application is a National Stage Entry of International Patent Application No. PCT/SG2018/050102, filed on Mar. 5, 2018, which claims the benefit of priority to Singapore Patent Application No. 10201701882Y, filed on Mar. 6, 2017, the entire contents and disclosure of which are hereby incorporated by reference herein.

### BACKGROUND

The present disclosure relates to card-based payment systems for effecting card-based transactions, such as credit or debit card payments, and in particular to a customer-initiated payment system and process.

Card-based payment systems using physical payment cards such as credit cards and debit cards are ubiquitous in today's society, and are widely used for payment transactions at points-of-sale (POS) (e.g., brick and mortar stores) and on the Internet (so-called ‘online’ or ‘electronic commerce’ transactions). However, the ubiquity of smartphones and other portable electronic devices has given rise to the “digital wallet” technologies such as Apple Pay™, Android Pay™, and Samsung Pay™ that allow customers to make purchases and other forms of payment using these portable electronic devices in place of a physical payment card.

For example, in order to make a payment to a merchant, a customer having a smartphone equipped with a near-field communications (NFC) chip can place their smartphone in close proximity to a NFC-equipped point-of-sale (POS) terminal device of the merchant to communicate payment information between the POS terminal device and an Apple Pay™ or Android Pay™ digital wallet application executing on the customer's smartphone to initiate payment from the customer to the merchant, depending on whether the customer's smartphone is running Apple's iOS operating system or an Android operating system. One difficulty with this arrangement is that it requires both the customer's smartphone and the merchant's POS terminal to be equipped with NFC chips, and this requirement may be responsible for inhibiting the widespread adoption of digital wallet technology, and effectively prohibits its use in many circumstances, for example, in developing countries where NFC-capable POS terminals may not be available, or may be prohibitively expensive for smaller merchants.

FIG. 1 is a schematic diagram of the current state of the art, illustrating the high-level steps that are typically involved when a customer uses a digital wallet on a smartphone or similar portable electronic device to purchase goods and/or services from a merchant. In this and other examples provided herein, the transactions are performed using Apple Pay™, an Apple iPhone, and Mastercard Digital Enablement Service (MDES); however, the principles apply equally to other payment services that may employ alternative digital wallet applications and tokenization systems.

The overall process begins with the customer registering their conventional payment card details with the MDES token service 122 at step 102. This involves the customer (via interface 124 of an issuer application or ‘app’) providing their Primary Account Number (PAN), in this example being “511 111 111 1234”, and other payment account information such as CVV (card verification value) and expiry date to the digital wallet application on their smartphone. The digital wallet application forwards the information to the MDES token service 122, which responds at step 104 with an alternative card number referred to in the art as a “token”, in this example being “5123 *** *** 9876”. The token is securely stored in association with the digital wallet application on the customer's smartphone (iPhone), and is also stored by the MDES token service 122 in association with the customer's PAN.

Having registered the payment card details with the MDES token service 122 and received the corresponding token, the customer can now use the token to make payments. Accordingly, at step 106, the customer goes shopping, and decides to purchase goods and/or services from a merchant. The customer makes a face-to-face request of a salesperson of the merchant, indicating that he or she wishes to purchase (or in some cases has already utilised or consumed) specific goods and/or services.

The technical payment process whereby the customer pays for those goods and/or services is initiated by the merchant. First, the salesperson of the merchant uses some form of interactive POS device, which is commonly an electronic cash register with a touchscreen interface, into which the salesperson provides inputs indicating the goods and/or services to be purchased. Usually, the POS device will retrieve or calculate the relevant transaction amount. In some cases, the POS device is coupled to a mounted NFC-enabled POS reader, but commonly this is not the case, and the salesperson must locate an independent hand-held NFC-enabled POS terminal/reader (often these costly devices are used by multiple salespersons and are not necessarily immediately available, or always available in the same location within the merchant's premises). In the latter case, the salesperson must also manually type the transaction amount into the POS terminal/reader before presenting it to the customer.

In either case, once the NFC-enabled POS terminal/reader has received the transaction amount information, at step 108 the customer places their smart phone in close proximity to the NFC-enabled POS terminal/reader so that the latter can securely obtain the customer's token from the smart phone via the smartphone's NFC chip (after biometric authentication of the customer via an interface 126 of the issuer app).

At step 110, the POS terminal sends a transaction request message including the customer's token and the transaction amount to the merchant's acquirer 128, effectively asking the acquirer 128 to initiate, if possible, the transaction. In turn, at step 112, the acquirer 128 sends a corresponding transaction request to the MDES token service 122 via the corresponding card provider network. At step 114, the MDES token service 122 uses the token to look up the customer's corresponding actual payment card account number (PAN); that is, the token value of “5123 *** *** 9876” is mapped to the customer's PAN “511 111 111 1234”, and the PAN and transaction amount are forwarded to the customer's issuer 130 for approval. Assuming that the customer's account is in good standing, and has sufficient funds to cover the requested transaction amount, the issuer 130 approves the transaction and informs the MDES token service 122, which in turn informs the merchant's acquirer 128 at step 116, which in turn sends a corresponding message to the merchant's POS terminal at step 118 to inform the merchant (and the customer) that the transaction has been approved. At step 120, the MDES token service 122 sends a corresponding message to the customer's smart phone, informing them of the approved transaction (via interface 132 of the issuer app), including the transaction amount and partially masked PAN.

While this process is extremely convenient, a shortcoming with such existing processes is that they nevertheless require that both the customer and the merchant are equipped with NFC-capable electronic devices. Accordingly, a new system and process for payments that overcomes this difficulty, and also provides many advantages over existing payment systems and processes, would be desirable.

Despite the significant improvements in convenience and security of these technologies, there remains room for improvement.

It is desired, therefore, to provide a system and process that alleviate one or more difficulties of the prior art, or to at least provide a useful alternative.

### BRIEF DESCRIPTION

In a first aspect, there is provided a customer-initiated payment system, including: an electronic device of a customer, the electronic device including random access memory, non-volatile storage, a display, one or more interfaces to respective communications networks, and at least one processor configured to: process, in response to input from the customer, a digital image of a machine-readable optical code of a merchant to determine corresponding merchant information and transaction information encoded in the machine-readable optical code; access a digital wallet of the customer's electronic device to determine a token that identifies a financial transaction account of the customer; process the determined information and token to generate a transaction request message representing an identifier of the merchant, a transaction amount, and the token of the customer; and send the transaction request message to a token server to request a financial transaction involving payment of the transaction amount from the financial transaction account of the customer to a financial transaction account of the merchant.

There is also provided a computer-implemented customer-initiated payment process, the process being executed by one or more processors of one or more electronic devices, and including the steps of: processing, by at least one processor of an electronic device of a customer, and in response to input from the customer, a digital image of a machine-readable optical code of a merchant to determine corresponding merchant information encoded in the machine-readable optical code; accessing a digital wallet of the customer's electronic device to determine a token that identifies a financial transaction account of the customer; generating, from the token and the determined information, a transaction request representing an identifier of the merchant, a transaction amount, and the token of the customer; and sending the transaction request to a token server to request a financial transaction involving payment of the transaction amount from the financial transaction account of the customer to a financial transaction account of the merchant.

### BRIEF DESCRIPTION OF THE DRAWINGS

Some embodiments of the present disclosure are hereinafter described, by way of example only, with reference to the accompanying drawings, wherein:

FIG. 1 is a schematic diagram illustrating the steps and components involved in a conventional Apple Pay™ payment process;

FIG. 2 is a block diagram of a customer-initiated payment system in accordance with some embodiments of the present disclosure;

FIG. 3 is a schematic diagram showing components of a server of the system shown in FIG. 2;

FIG. 4 is a flow diagram of a customer-initiated payment process in accordance with some embodiments the present disclosure;

FIG. 5 is a schematic diagram illustrating the process steps and system components involved in the customer-initiated payment process and system;

FIG. 6 is a first example of a static QR code in accordance with some embodiments of the present disclosure;

FIG. 7 is a second example of a static QR code in accordance with some embodiments of the present disclosure; and

FIG. 8 is an example of a dynamic QR code in accordance with some embodiments of the present disclosure.

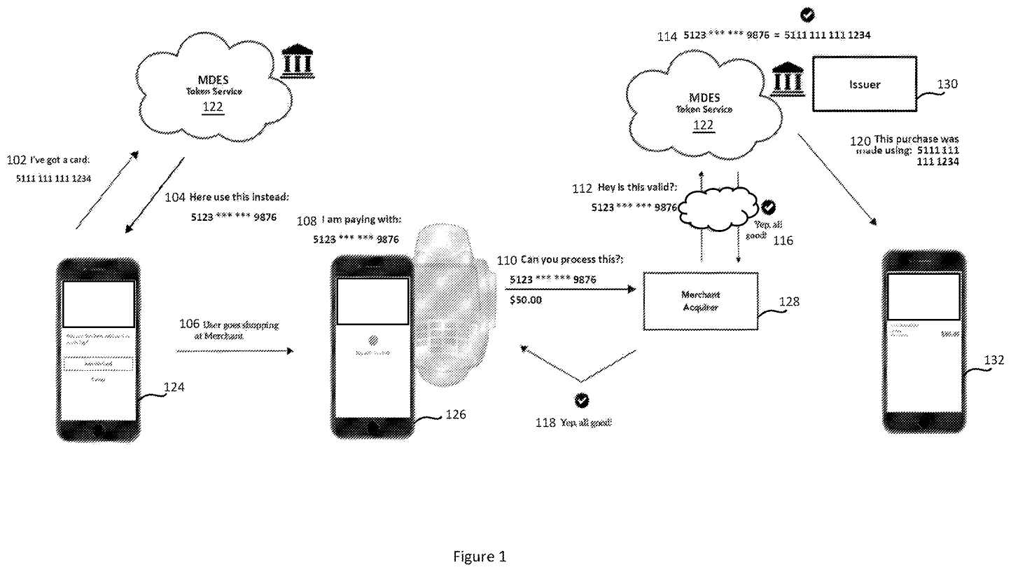

### DETAILED DESCRIPTION

Some embodiments of the present disclosure are described herein in the context of the MasterCard Digital Enablement Service (MDES). However, it will be apparent to those skilled in the art that other digital wallet services can be used in other embodiments of the present disclosure.

A significant characteristic of the new payment processes described herein is that they are customer-initiated; that is, it is the customer who initiates the technical payment process. In particular, there is typically no need for any human involvement whatsoever on the part of the merchant, because once the customer initiates the payment process, the subsequent steps can occur automatically.

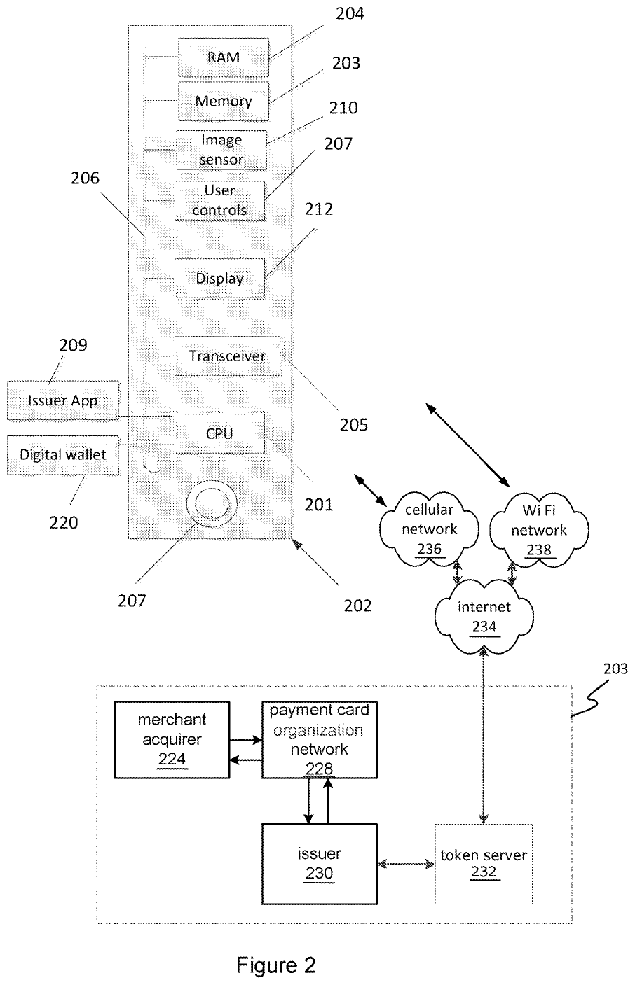

As shown in FIG. 2, a customer-initiated payment system includes an electronic device 202 of the customer and financial institution systems/servers 203. In the exemplary embodiment shown in FIG. 2, the electronic device 202 is the customer's smartphone, although it can be another form of electronic device in other embodiments, including not only a portable electronic device such as a tablet or laptop computer, but can even be a desktop computer.

### Electronic Device 202

The electronic device 202 of any of the examples herein may be a handheld computer device such as a smart phone or a PDA such as one manufactured by Apple™, LG™, HTC™, Research In Motion™, or Motorola™. The electronic device 202 may include a mobile computer such as a tablet computer or a wearable mobile processing device such as a smart watch. As shown, the electronic device 202 includes the following components in electronic communication via a bus 206:

1. a display 212;
2. non-volatile memory 203;
3. random access memory (“RAM”) 204;
4. an image sensor 210;
5. N processing components 201;
6. a transceiver component 205 that includes N transceivers; and
7. user controls 207.

Although the components depicted in FIG. 2 represent physical components, FIG. 2 is not intended to be a hardware diagram; thus many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 212 generally operates to provide a presentation of content to a user, and may be realized by any of a variety of displays (e.g., CRT, LCD, HDMI, micro-projector and OLED displays). And in general, the non-volatile memory 203 functions to store (e.g., persistently store) data and executable code including code that is associated with the functional components of a browser component and applications, and in one example, an issuer application 209 executing on the electronic device 202 and a digital wallet 220 executing on the electronic device 202. In some embodiments, for example, the non-volatile memory 203 includes bootloader code, modem software, operating system code, file system code, and code to facilitate the implementation of one or more portions of the application 209 and the digital wallet 220 as well as other components well known to those of ordinary skill in the art that are not depicted for simplicity.

In many implementations, the non-volatile memory 203 is realized by flash memory (e.g., NAND or ONENAND memory), but it is certainly contemplated that other memory types may be utilized as well. Although it may be possible to execute the code from the non-volatile memory 203, the executable code in the non-volatile memory 203 is typically loaded into RAM 204 and executed by one or more of the N processing components 201.

The N processing components 201 in connection with RAM 204 generally operate to execute the instructions stored in non-volatile memory 203 to effectuate the functional components. As one of ordinarily skill in the art will appreciate, the N processing components 201 may include a video processor, modem processor, DSP, graphics processing unit (GPU), and other processing components.

The transceiver component 205 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

As will be familiar to those skilled in the art, the financial institution systems/servers 203 include an acquirer organisation 224 (e.g., the merchant's banking institution) an issuer institution 226 (e.g., the customer's banking institution), and a payment card organization network 228 that securely exchanges payment card-related messages between the acquirer 224 and issuer 230 systems/servers. In accordance with the described embodiment of the present disclosure, also included in the financial institution systems/servers 203 is a token server 232 that implements some steps of the customer-initiated payment process of FIG. 2.

### Server Used in Some Embodiments

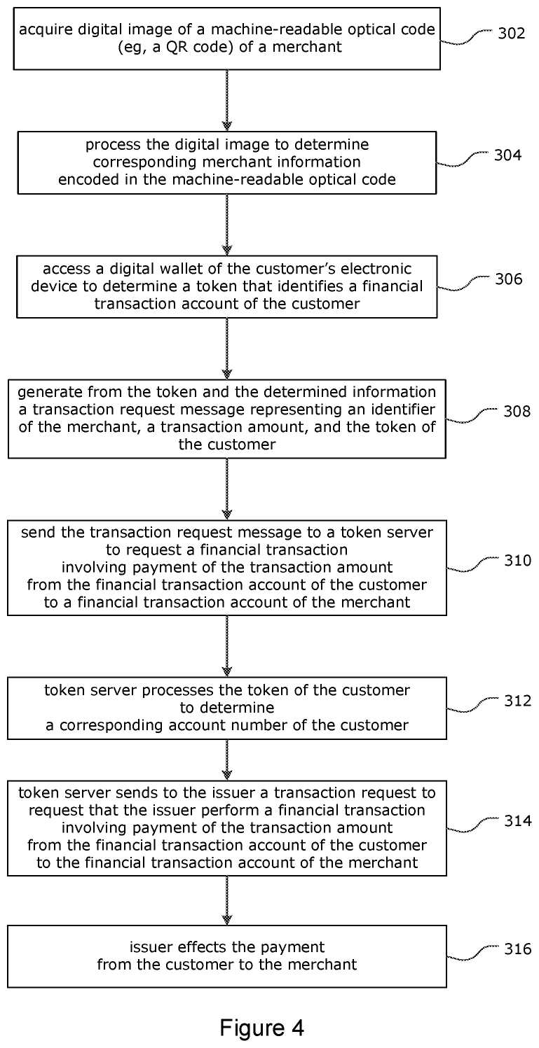

An exemplary example of servers deployed in the system of FIG. 2 will now be described in FIG. 4. The server 700 is able to communicate within the system 10 over a communications network 900 using standard communication protocols.

The components of the issuer server 700 can be configured in a variety of ways. The components can be implemented entirely by software to be executed on standard computer server hardware, which may include one hardware unit or different computer hardware units distributed over various locations, some of which may require the communications network 900 for communication. A number of the components or parts thereof may also be implemented by application specific integrated circuits (ASICs) or field programmable gate arrays.

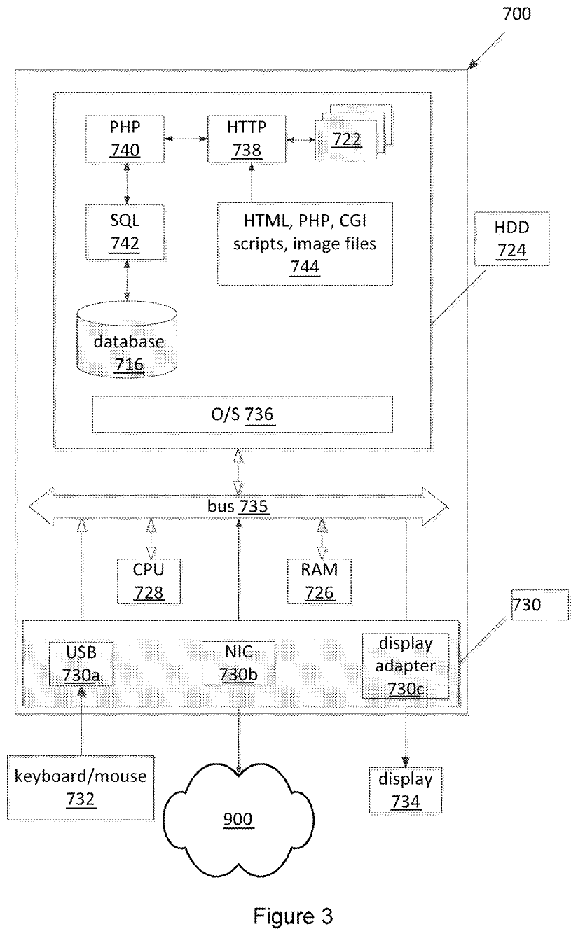

In the example shown in FIG. 3, the server 700 is a commercially available server computer system based on a 32 bit or a 64 bit Intel architecture, and the processes and/or methods executed or performed by the server 700 are implemented in the form of programming instructions of one or more software components or modules 722 stored on non-volatile (e.g., hard disk) computer-readable storage 724. At least parts of the software modules 722 could alternatively be implemented as one or more dedicated hardware components, such as application-specific integrated circuits (ASICs) and/or field programmable gate arrays (FPGAs).

The server 700 includes at least one or more of the following standard, commercially available, computer components, all interconnected by a bus 735:

1. random access memory (RAM) 726;
2. at least one computer processor 728, and
3. external computer interfaces 730:
a. universal serial bus (USB) interfaces 730a (at least one of which is connected to one or more user-interface devices, such as a keyboard, a pointing device (e.g., a mouse 732 or touchpad)),
b. a network interface connector (NIC) 730b, which connects the server 700 to a data communications network, such as the Internet 900; and
c. a display adapter 730c, which is connected to a display device 734 such as a liquid-crystal display (LCD) panel device.

Each server 700 includes a plurality of standard software modules, including:

1. an operating system (OS) 736 (e.g., Linux or Microsoft Windows);
2. web server software 738 (e.g., Apache, available at http://www.apache.org);
3. scripting language modules 740 (e.g., personal home page or PHP, available at http://www.php.net, or Microsoft ASP); and
4. structured query language (SQL) modules 742 (e.g., MySQL, available from http://www.mysql.com), which allow data to be stored in and retrieved/accessed from an SQL database 742.

Together, the web server 738, scripting language 740, and SQL modules 742 provide the server 700 with the general ability to allow users of the Internet 900 with electronic devices 202 equipped with standard web browser software and/or a digital wallet App 220 to access the server 700 and in particular to provide data to and receive data from the database 716. It will be understood by those skilled in the art that the specific functionality provided by the server 700 to such users is provided by scripts accessible by the web server 738, including the one or more software modules 722 implementing the processes performed by the electronic device 202, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 700 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the server 700 to perform the functions of the module.

The server 700 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

The customer's smart phone 202 communicates with the token server 232 via a communications network such as the Internet 234, which the smartphone 202 accesses through a cellular telephone network 236 and/or a WiFi network 238 and the transceiver 205 (for simplicity of description, a Bluetooth interface is not shown or described, but may be used in some embodiments).

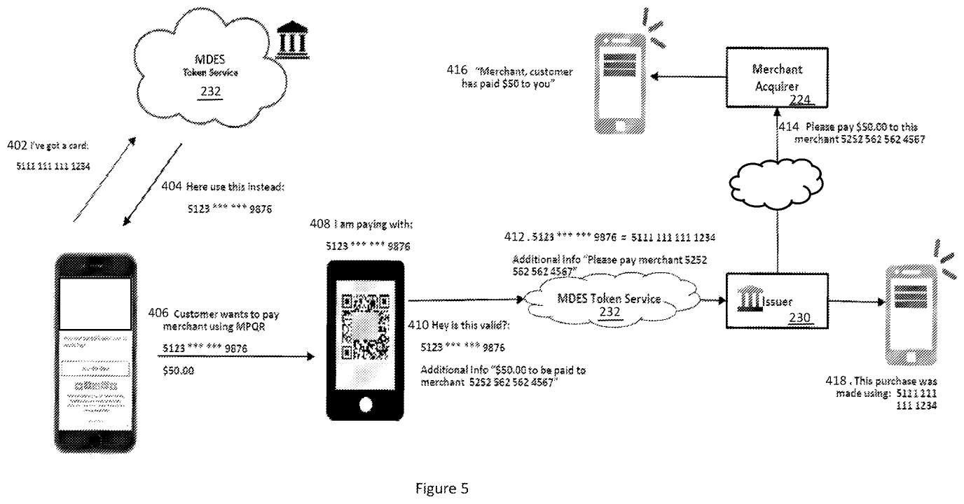

In order for a customer to use the customer-initiated payment system and process, a customer registers a card-based payment account with the token server 232 (refer to step 402 of FIG. 5), in the same general manner described above, and (at 404 of FIG. 5) receives a corresponding tokenised account number or ‘token’ that is stored in the digital wallet 220 on the customer's smartphone 202. However, if the customer has not already done so, the customer downloads to the smartphone 202 from the smartphone manufacturer or operating system provider an application 209 referred to herein for convenience as the ‘payment app’ 209.

In order for a merchant to use the customer-initiated payment system and process, the merchant registers with the payment system a banking account with their acquiring institution, and receives a corresponding machine-readable optical code which is encoded with information about the merchant, and optionally also transaction information, as described below.

In the described embodiments of the present disclosure, the machine-readable optical code is in the form of a QR code, which is a type of two-dimension of barcode known to those skilled in the art, and described in a number of ISO/IEC standards; however, it will be apparent to those skilled in the art that other forms of machine-readable optical codes may be used in other embodiments. The QR code may be a Micro QR code, an IQR code, or any other variant.

Having received the machine-readable optical code, in this example being a QR code, the merchant displays it in association with the merchant's goods and/or services, as the case may be. A customer wishing to purchase the merchant's goods and/or services simply accesses the payment app 209 on their smart phone 202 (refer 406 of FIG. 5). After authenticating themselves with the payment app 209 (e.g., by biometric authentication such as fingerprint recognition, a PIN code, or the like), the customer can initiate a payment transaction with the merchant, as follows.

In response to the customer selecting a button or other control indicating that the customer wishes to make a payment to a merchant, the payment app 209 activates the smartphone's image sensor 210 to generate a digital image of the machine-readable optical code at step 302 of the payment process of FIG. 4. At step 304, the payment app 209 then processes the resulting digital image to determine the corresponding merchant information (and transaction information, if present) encoded into the machine-readable optical code. Software libraries for decoding QR codes are generally available.

If the merchant's QR code did not encode transaction information, or if the encoded transaction information did not include a price or transaction amount, then the payment app 209 prompts the customer to enter a transaction amount using the touchscreen display 212 or other input of the smartphone 202.

If the decoded information appears to be valid and no errors have occurred, then at step 306 (also refer 408 of FIG. 5) the payment app 209 accesses the digital wallet 220 on the customer's smartphone 202 to obtain the customer's token. At step 308, the payment app 209 generates a transaction request that includes or otherwise represents at least the customer's token from the digital wallet 220, the merchant identifier determined from the QR code, and the transaction amount (determined from the QR code, or if not present, then entered by the customer). At step 310 (also refer to 410 of FIG. 5), the payment app 209 causes the transaction request to be sent to the token server 232 via the Internet 234, and either the Wi-Fi network 238 (if available and the customer's smart phone 202 has established a connection to the Wi-Fi network 238), or the cellular network 236.

As will be apparent to those skilled in the art, the sending of the transaction request to the token server 232 does not require that the token server 232 receives the transaction request in the same form as it was sent, because there may be one or more intermediary servers or components that perform some processing on the transaction request so that the token server 232 receives a corresponding transaction request having a different form to that sent from the customer's smart phone 202. Consequently, all such phrases in this specification should be understood to encompass such modifications during transmission.

The transaction request is received by the token server 232 (also refer to 412 of FIG. 5), and as described in the previous paragraph, the received transaction request may not be identical to that sent by the customer's smart phone 202, but rather may be a corresponding transaction request providing same information.

At step 312, the token server 232 processes the token to determine a corresponding account number of the customer, being the customer's PAN. At step 314, the token server 232 sends to the issuer server 230 a transaction request to request that the issuer 230 perform a financial transaction involving payment of the transaction amount from the financial transaction account of the customer to a financial transaction account of the merchant.

At step 316, the issuer 230 performs the usual checks (including that the customer's payment account has sufficient funds to cover the transaction), and if there are no issues, then performs the transaction to transfer the corresponding funds from the customer's account to the merchant's account, including sending (refer to 414 of FIG. 5) a corresponding transaction request to the acquirer server 224 of the merchant's bank via the payment card organization network 228.

The merchant's acquirer 224 causes an electronic message to be sent to the merchant (refer 416 of FIG. 5) confirming that the transaction amount has been received. Similarly, the customers issuer 230 causes an electronic message to be sent to the customer (refer 418 of FIG. 5), confirming that the transaction amount has been paid to the merchant. These messages can be sent by any suitable means, including short message service (SMS), or in the case of the message sent to the customer, within the issuer app 209.

Thus the customer-initiated payment process and system described herein allow customers to make payments to any merchant or other entity (e.g., individuals or charities) using their smartphone or other portable computing device, and without requiring any payment terminal at all to be present, let alone a payment terminal equipped with an NFC chip, a card reader, or a magnetic stripe reader. This can be particularly advantageous in developing markets where smartphone ownership has far exceeded the deployment of payment terminals.

In accordance with some embodiments of the present disclosure, some QR codes can be generated ‘on-the-fly’ or dynamically by the merchant for a single transaction. Such QR codes are referred to herein as ‘dynamic’ QR codes, in contrast to ‘static’ QR codes which may, for example, be printed onto a sign or label and permanently affixed to products or displayed at a merchant location, for example.

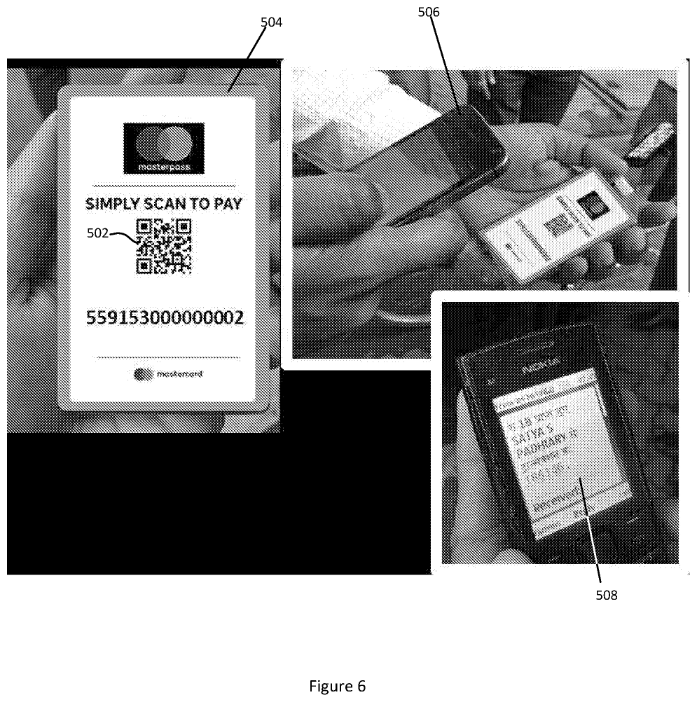

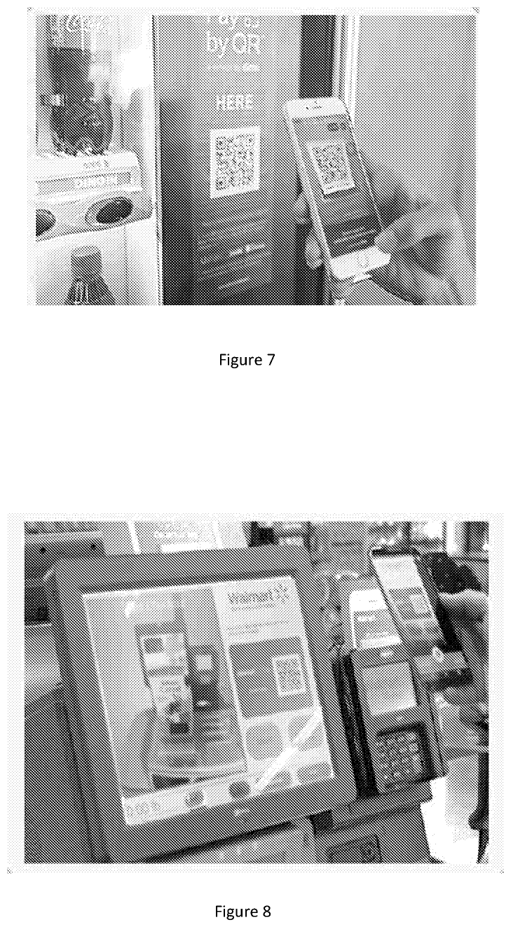

For example, FIG. 6 illustrates a static QR code 502 on a printed card or label 504, the scanning of that static QR code 502 using a mobile phone 506, and the resulting message 508 (in this example, being an SMS message, a voice message, a text message on a messaging platform or any digital form of receipt) displayed on the customer's mobile phone 506. FIG. 7 illustrates the use of a mobile phone to scan a QR code displayed on a vending machine. In this instance, the QR code may be a fixed and static QR code that uniquely identifies a payment account (and correspondingly, an entity associated with the payment account) that will receive the payment, or may be a QR code dynamically generated based on the item to be purchased that includes, for example, information on a transaction amount, an identifier of the specific vending machine and a timestamp representing the date and time of purchase. In any case, the use of QR codes negates any need for the vending machine to include an NFC or payment card scanner.

Finally, FIG. 8 illustrates a dynamically generated QR code that is generated for a single customer self-checkout purchase transaction at a store, representing at least the total transaction amount for the products purchased by the customer in that transaction. Thus the payment can be made using only the customer's mobile phone at the point of sale, without any need for a merchant payment terminal. Similarly, the described process and system can facilitate the payment at restaurants and similar venues, including ‘pay-at-table’ payments.

The ease in which payments can be made using embodiments of the present disclosure can lower barriers to making certain types of payments, particularly without a need to install an issuer app on the smartphone. For example, charities often have individuals in public locations, attempting to persuade passers-by to make donations to particular charities. If a person could make either a single donation, or perhaps sign up for regular donations (the latter subject to subsequent approval) by simply using their smartphone to scan a QR code, then it is likely that many more donations would be received. In another example, the ease of making payments as described herein may facilitate the paying of rent by individual tenants to landlords without having to manually confirm and enter the correct amount, determine the landlord's bank details, and so on. Similarly, the described process and system can be used to provide a secure alternative to cash on delivery, where, for example, delivery of a product is completed after the customer makes a payment using the customer's smart phone, and the delivery personal receives confirmation of that payment. This can also be used for paying for service delivery (e.g., tradesmen) on the spot, and other B2B transactions.

Many other uses of the described process and system will be apparent in light of this disclosure.

Many modifications will be apparent to those skilled in the art without departing from the scope of the present disclosure.

1. A customer-initiated payment system comprising:
an electronic device of a customer, the electronic device including random access memory, non-volatile storage, a display, one or more interfaces to respective communications networks, and at least one processor configured to:
process, in response to input from the customer, a digital image of a machine-readable optical code of a merchant to determine corresponding merchant information and transaction information encoded in the machine-readable optical code;
access a digital wallet of the customer's electronic device to determine a token that identifies a financial transaction account of the customer;
process the determined information and token to generate a transaction request message representing an identifier of the merchant, a transaction amount, and the token of the customer; and
send the transaction request message to a token server to request a financial transaction involving payment of the transaction amount from the financial transaction account of the customer to a financial transaction account of the merchant.

2. The payment system of claim 1, wherein the at least one processor is further configured to generate the digital image of the machine-readable optical code of the merchant using an imaging sensor of the electronic device of the customer.

3. The payment system of claim 1, wherein the at least one processor is further configured to:
receive, at the electronic device of the customer, a customer transaction status message representative of whether the financial transaction was approved; and
process the transaction status message to display, on the electronic device of the customer, information informing the customer whether the financial transaction was approved.

4. The payment system of claim 1, wherein the at least one processor is further configured to send a merchant transaction status message to an electronic device of the merchant to inform the merchant that the payment amount has been received.

5. The payment system of claim 1, wherein the at least one processor is configured to process the digital image of the machine-readable optical code to determine the corresponding merchant information and corresponding transaction information encoded in the machine-readable optical code.

6. The payment system of claim 5, wherein the transaction information encoded in the machine-readable optical code includes the payment amount.

7. The payment system of claim 1, wherein the at least one processor is further configured to display a payment amount prompt on the electronic device of the customer to prompt the customer to enter the payment amount.

8. The payment system of claim 1, wherein the machine-readable optical code of the merchant is a form of QR code.

9. The payment system of claim 1, further comprising a token server configured to:
receive the transaction request representing the identifier of the merchant, the transaction amount, and the token of the customer;
process the token of the customer to determine a corresponding account number of the customer; and
send to an issuer corresponding to the account number of the customer, a transaction request representing the account number of the customer, an identifier of the merchant, and the transaction amount to request that the issuer perform the financial transaction involving payment of the transaction amount from the financial transaction account of the customer to the financial transaction account of the merchant.

10. A computer-implemented customer-initiated payment process, the process being executed by one or more processors of one or more electronic devices, and comprising the steps of:
processing, by at least one processor of an electronic device of a customer, and in response to input from the customer, a digital image of a machine-readable optical code of a merchant to determine corresponding merchant information encoded in the machine-readable optical code;
accessing a digital wallet of the customer's electronic device to determine a token that identifies a financial transaction account of the customer;
generating, from the token and the determined information, a transaction request representing an identifier of the merchant, a transaction amount, and the token of the customer; and
sending the transaction request to a token server to request a financial transaction involving payment of the transaction amount from the financial transaction account of the customer to a financial transaction account of the merchant.

11. The computer-implemented payment process of claim 10, further comprising generating the digital image of the machine-readable optical code of the merchant using an imaging sensor of the electronic device of the customer.

12. The computer-implemented payment process of claim 10, further comprising:
receiving, at the electronic device of the customer, a customer transaction status message representative of whether the financial transaction was approved; and
processing the transaction status message to display, on the electronic device of the customer, information informing the customer whether the financial transaction was approved.

13. The computer-implemented payment process of claim 10, further comprising sending a merchant transaction status message to an electronic device of the merchant to inform the merchant that the payment amount has been received.

14. The computer-implemented payment process of claim 10, wherein processing the digital image comprises determining corresponding transaction information encoded in the machine-readable optical code.

15. The computer-implemented payment process of claim 14, wherein the transaction information encoded in the machine-readable optical code includes the payment amount.

16. The computer-implemented payment process of claim 10, including further comprising displaying a payment amount prompt on the electronic device of the customer to prompt the customer to enter the payment amount.

17. The computer-implemented payment process of claim 10, wherein the machine-readable optical code of the merchant is a form of QR code.

18. The computer-implemented payment process of claim 10, further comprising:
receiving, at the token server, the transaction request representing the identifier of the merchant, the transaction amount, and the token of the customer;
processing, by the token server, the token of the customer to determine a corresponding account number of the customer; and
sending, from the token server to an issuer corresponding to the account number of the customer, a transaction request representing the account number of the customer, an identifier of the merchant, and the transaction amount to request that the issuer perform the financial transaction involving payment of the transaction amount from the financial transaction account of the customer to the financial transaction account of the merchant.

19. At least one computer-readable non-volatile storage medium having stored thereon processor-executable instructions that, when executed by at least one processor of an electronic computing device, cause the at least one processor to execute the customer-initiated payment process of claim 10.
